(19) United States
(12) Patent Application Publication
(10) Pub. No.: US 2012/0311452 A1
(43) Pub. Date: Dec. 6, 2012

(54) SERVER APPARATUS THAT MAKES IT POSSIBLE TO EFFECTIVELY UTILIZE DRIVER FUNCTION, INFORMATION PROCESSING APPARATUS, METHOD OF CONTROLLING THE APPARATUSES, AND STORAGE MEDIUM

(75) Inventor: Shinichi TAKANO, Yokohama-shi (JP)

(73) Assignee: CANON KABUSHIKI KAISHA, Tokyo (JP)

(21) Appl. No.: 13/478,331

(22) Filed: May 23, 2012

(30) Foreign Application Priority Data
Jun. 1, 2011 (JP) 2011-123639

(51) Int. Cl. G06F 15/16; G06F 3/01

(52) U.S. Cl. 715/738; 709/217

(57) ABSTRACT

An arrangement for making effective use of driver functions available in an information processing apparatus when using an image input service provided by a server apparatus on a network. A server apparatus which is capable of communicating with an information processing apparatus creates a list of image input apparatuses, and provides the created list to the information processing apparatus. The server apparatus provides a search script to the information processing apparatus, for searching the information processing apparatus for a driver for using a selected image input apparatus. When it is determined that the driver exists in the information processing apparatus, a driver control program for controlling the driver is provided to the information processing apparatus. Image data input by the image input apparatus using the driver controlled by the driver control program is acquired via the information processing apparatus, and is stored in the server apparatus.

### BACKGROUND OF THE INVENTION

1. Field of the Invention

The present invention relates to a server apparatus for inputting images using a network, an information processing apparatus, a method of controlling the server apparatus and the information processing apparatus, and a storage medium.

2. Description of the Related Art

To use a peripheral apparatus, such as an image input apparatus, from an information processing apparatus, generally, it is necessary to install a specific device driver compatible with the peripheral apparatus (e.g. a scanner driver in the case of an image input apparatus) in an operating system (hereinafter referred to as the “OS”) which operates on the information processing apparatus.

When using an image input apparatus, a scanner driver is started from an application, settings necessary for a scanning operation are made, the image input apparatus is driven, and then acquired image data is transferred to the application, whereby the application is enabled to freely handle the image data.

Therefore, scanner drivers have been made available each of which is compatible with both of an image input apparatus to be used and an OS operating on an information processing apparatus.

On the other hand, there has been proposed a method of realizing a function equivalent to the operation of a scanner driver by accessing a Web page hosted by a PC (personal computer) which is directly connected to an image input apparatus, instead of using the scanner driver (see e.g. Japanese Patent Laid-Open Publication No. 2000-148649).

In this case, the information processing apparatus which accesses the web page is not required to have a scanner driver installed therein.

Further, in recent years, a wide range of various uses of images have been made possible through image processing realized by so-called cloud computing which is a web service application operating on server apparatuses on the Internet.

As a method of transferring an image to a server apparatus on the Internet, the following technique is used: An image file is transferred from an information processing apparatus being in use to a desired server apparatus using a menu option, such as image upload, which is integrated in a web page opened by a web browser application. Image file transfer by a dedicated application for file transfer or the like is also widely used.

In an image input system using a web browser, disclosed in Japanese Patent Laid-Open Publication No. 2000-148649, a server apparatus connected to the image input apparatus, i.e. the aforementioned PC, is required to be provided within a local network. Further, the server apparatus is required to be provided with an arrangement and settings with which the image input apparatus can be controlled.

Therefore, there is not only a problem that the work of preparation for setting up the environment is complicated but also a problem that it is impossible to use the server apparatus in a case where the server apparatus is located on the Internet outside the local network.

To solve the above-mentioned problems, it is possible to envisage the following image input system: First, an image input service provided by a server apparatus on the Internet is started by a web browser operating on an information processing apparatus.

Then, the information processing apparatus downloads a script from the server apparatus and executes the script. Further, the information processing apparatus transmits (broadcasts) a search protocol-based message to the local network to thereby search for an image input apparatus, and then transfers information on the image input apparatus found by the search to the server apparatus.

After that, the information processing apparatus transfers a scan command signal transmitted from the server apparatus to the image input apparatus, whereby the image input apparatus performs scan processing and transmission processing for transmitting image information. The information processing apparatus transfers the image information transmitted from the image input apparatus to the server apparatus.

This makes it possible for the information processing apparatus to constitute an image input system which enables use of a wide range of storage functions on the Internet, without requiring complicated settings of the server apparatus and the like to be made in advance.

However, the image input service provided by the server apparatus can be accessed from the web browser operating on the information processing apparatus. Further, there is a possibility that the information processing apparatus is in such an operating environment, as typified by that of a desktop PC, in which a sufficient local storage capacity is provided and a scanner driver compatible with the image input apparatus can be used. In such a case, however, in the envisaged image input system, the information processing apparatus cannot use a wealth of functions of the scanner driver and make use of the advantage of performance thereof.

### SUMMARY OF THE INVENTION

The present invention provides an arrangement for making effective use of driver functions available in an information processing apparatus when using an image input service provided by a server apparatus on a network.

In a first aspect of the present invention, there is provided a server apparatus which is capable of communicating with an information processing apparatus, comprising a search script-providing unit configured to provide a search script to the information processing apparatus, for use in searching for a driver for using an image input apparatus selected by the information processing apparatus, a program providing unit configured to be operable when it is determined by the search script provided by the search script-providing unit that the driver exists in the information processing apparatus, to provide a driver control program for controlling the driver to the information processing apparatus, and a storage unit configured to acquire image data input by the image input apparatus using the driver controlled by the driver control program via the information processing apparatus, and store the acquired image data.

In a second aspect of the present invention, there is provided an information processing apparatus which is capable of communicating with a server apparatus and an image input apparatus, comprising a selection screen display unit configured to acquire a list of image input apparatuses from the server apparatus, and display a selection screen for prompting a user to select an image input apparatus to be operated from the list, a selection result-transmitting unit configured to transmit a selection result indicative of the image input apparatus selected by the user via the selection screen displayed by the selection screen display unit to the server apparatus, a first acquisition unit configured to acquire a search script from the server apparatus, for use in searching for a driver for using an image input apparatus indicated by the selection result transmitted by the selection result-transmitting unit, a second acquisition unit configured to be operable when it is determined by the search script acquired by the first acquisition unit that the driver exists in the information processing apparatus, to acquire a driver control program for controlling the driver from the server apparatus, a display unit configured to display a setting screen for setting a manner of operation of the image input apparatus using the driver started by the driver control program acquired by the second acquisition unit, and a control unit configured to control the image input apparatus by transmitting a job command indicative of the manner of operation set by the user from the setting screen displayed by the display unit to the image input apparatus.

In a third aspect of the present invention, there is provided a method of controlling a server apparatus which is capable of communicating with an information processing apparatus, comprising providing a search script to the information processing apparatus, for use in searching for a driver for using an image input apparatus selected by the information processing apparatus, providing, when it is determined by the provided search script that the driver exists in the information processing apparatus, to provide a driver control program for controlling the driver to the information processing apparatus, and acquiring image data input by the image input apparatus using the driver controlled by the driver control program via the information processing apparatus, and store the acquired image data.

In a fourth aspect of the present invention, there is provided a method of controlling an information processing apparatus which is capable of communicating with a server apparatus and an image input apparatus, comprising acquiring a list of image input apparatuses from the server apparatus, and displaying a selection screen for prompting a user to select an image input apparatus to be operated from the list, transmitting a selection result indicative of the image input apparatus selected by the user via the displayed selection screen to the server apparatus, acquiring a search script from the server apparatus, for use in searching for a driver for using an image input apparatus indicated by the transmitted selection result, acquiring, when it is determined by the acquired search script that the driver exists in the information processing apparatus, to acquire a driver control program for controlling the driver from the server apparatus, displaying a setting screen for setting a manner of operation of the image input apparatus using the driver started by the acquired driver control program, and a control unit configured to control the image input apparatus by transmitting a job command indicative of the manner of operation set by the user from the displayed setting screen to the image input apparatus.

In a fifth aspect of the present invention, there is provided a non-transitory computer-readable storage medium storing a computer-executable program for executing a method of controlling a server apparatus which is capable of communicating with an information processing apparatus, wherein the method comprises providing a search script to the information processing apparatus, for use in searching for a driver for using an image input apparatus selected by the information processing apparatus, providing, when it is determined by the provided search script that the driver exists in the information processing apparatus, to provide a driver control program for controlling the driver to the information processing apparatus, and acquiring image data input by the image input apparatus using the driver controlled by the driver control program via the information processing apparatus, and store the acquired image data.

In a sixth aspect of the present invention, there is provided a non-transitory computer-readable storage medium storing a computer-executable program for executing a method of controlling an information processing apparatus which is capable of communicating with a server apparatus and an image input apparatus, wherein the method comprises acquiring a list of image input apparatuses from the server apparatus, and displaying a selection screen for prompting a user to select an image input apparatus to be operated from the list, transmitting a selection result indicative of the image input apparatus selected by the user via the displayed selection screen to the server apparatus, acquiring a search script from the server apparatus, for use in searching for a driver for using an image input apparatus indicated by the transmitted selection result, acquiring, when it is determined by the acquired search script that the driver exists in the information processing apparatus, to acquire a driver control program for controlling the driver from the server apparatus, displaying a setting screen for setting a manner of operation of the image input apparatus using the driver started by the acquired driver control program, and a control unit configured to control the image input apparatus by transmitting a job command indicative of the manner of operation set by the user from the displayed setting screen to the image input apparatus.

According to the present invention, it is possible to provide an arrangement for making effective use of driver functions available in an information processing apparatus when using an image input service provided by a server apparatus on a network.

Further features of the present invention will become apparent from the following description of exemplary embodiments with reference to the attached drawings.

### BRIEF DESCRIPTION OF THE DRAWINGS

FIG. 1 is a schematic block diagram of an image processing system according to an embodiment of the present invention.

FIG. 2 is a block diagram of an information processing apparatus and an image input apparatus, appearing in FIG. 1.

FIG. 3 is a block diagram of a server apparatus appearing in FIG. 1.

FIGS. 4A and 4B are sequence diagrams of a scanning process executed by the server apparatus, the information processing apparatus, and the image input apparatus, appearing in FIG. 1.

FIG. 5 is a view showing an example of a search-in-progress screen.

FIG. 6 is a view showing an example of an image input apparatus selection screen.

FIG. 7 is a view showing an example of a scan setting screen.

FIG. 8 is a view showing an example of a scan-in-progress screen.

FIG. 9 is a view showing an example of a scan operation completion screen.

FIGS. 10A and 10B are a flowchart of a scanning process executed by the information processing apparatus appearing in FIG. 1.

FIG. 11 is a flowchart of an installation process executed by the information processing apparatus appearing in FIG. 1.

FIG. 12 is a flowchart of a driver scanning process executed by the information processing apparatus appearing in FIG. 1.

FIGS. 13A and 13B are a flowchart of a scanning process executed by the server apparatus appearing in FIG. 1.

FIG. 14 is a flowchart of a scanning process executed by the image input apparatus appearing in FIG. 1.

FIG. 15 is a diagram showing an example of data transmission and reception performed according to a search script and a scan script when the search script and the scan script of the server apparatus are executed on a web browser of the information processing apparatus, and contents of transmitted and received data.

### DESCRIPTION OF THE EMBODIMENTS

The present invention will now be described in detail below with reference to the accompanying drawings showing embodiments thereof.

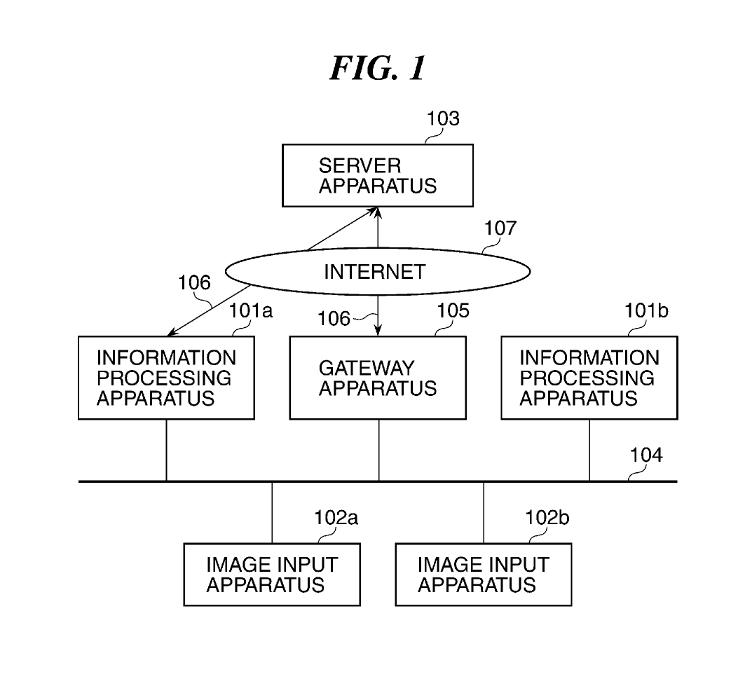

FIG. 1 is a schematic block diagram of an image processing system according to an embodiment of the present invention.

In FIG. 1, the image processing system includes information processing apparatuses 101a and 101b, image input apparatuses 102a and 102b, a gateway apparatus 105, and a server apparatus 103. In the following, in providing description applicable to both of the information processing apparatuses 101a and 101b, the information processing apparatuses 101a and 101b are referred to as the information processing apparatuses 101. Similarly, in providing description applicable to both of the image input apparatuses 102a and 102b, the image input apparatuses 102a and 102b are referred to as as the image input apparatuses 102. Further, although the two information processing apparatuses 101 and the two image input apparatuses 102 are shown in FIG. 1, these are examples, and the numbers of them are not limited to two.

The information processing apparatuses 101 and the image input apparatuses 102 are connected via a local network 104 constructed by Ethernet (registered trademark), and hence can communicate with each other. Further, the server apparatus 103 is connected to the information processing apparatus 101a via a network 106 including a mobile communication network, public lines, the Internet 107 and the like, or via the gateway apparatus 105 and the network 106. Therefore, the server apparatus 103, the information processing apparatuses 101, and the image input apparatuses 102 can communicate with each other. Further, the server apparatus 103 receives image data from the information processing apparatuses 101.

The image input apparatus 102 transmits image data to the information processing apparatus 101 and performs scanning.

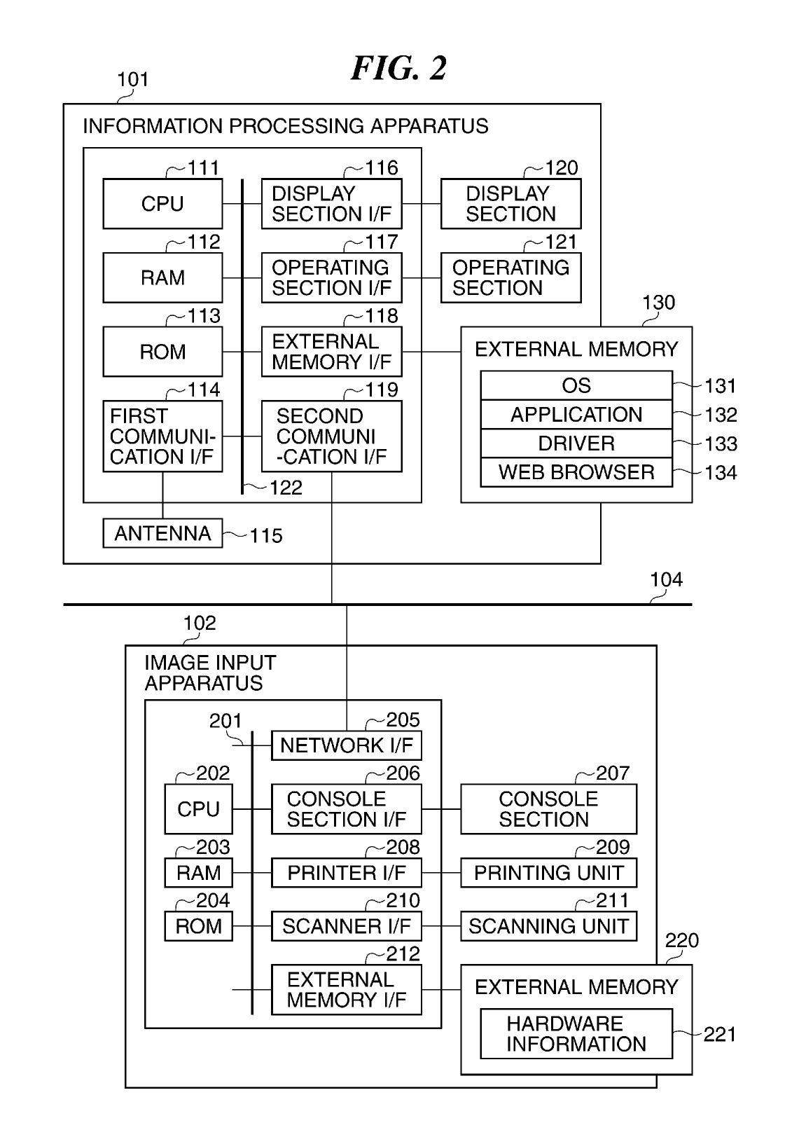

FIG. 2 is a block diagram of the information processing apparatus 101 and the image input apparatus 102, appearing in FIG. 1.

In FIG. 2, a CPU 111 of the information processing apparatus 101 controls the overall operation of devices connected to a system bus 122 according to a program stored in a RAM 112. The RAM 112 further functions as a main memory, a work area, and so forth, for the CPU 111.

A ROM 113 stores various kinds of programs and data. An operating section interface 117 controls key inputs from an operating section 121 or a pointing device (e.g. a touch panel), not shown.

A display section interface 116 controls contents to be displayed on a display section 120. An external memory interface 118 controls access to an external memory 130, such as a flash memory or an SSD (solid state disk).

The external memory 130 functions as a storage medium in which the information processing apparatus can store data or from which the information processing apparatus can read data. More specifically, the external memory 130 stores an OS (operating system) 131, various kinds of applications 132, a driver software 133 (hereinafter referred to as the “driver”), and a web browser 134.

A first communication interface 114 is a controller for communication e.g. via a mobile network, and establishes a network connection to a wireless base station via an antenna 115. A second communication interface 119 is a controller for a Wi-Fi wireless network and a preferred network, and enables connection to a local network via a Wi-Fi antenna or a network terminal, not shown.

Note that a script file which is executed on the web browser 134 is not initially stored in the external memory 130 of the information processing apparatus 101 which is newly used by a user. In the present embodiment, if a script file which controls construction of the scan system environment is not stored, the web browser 134 running on the OS 131 downloads a script from the server apparatus 103 into the information processing apparatus 101 and executes the script using the RAM 112.

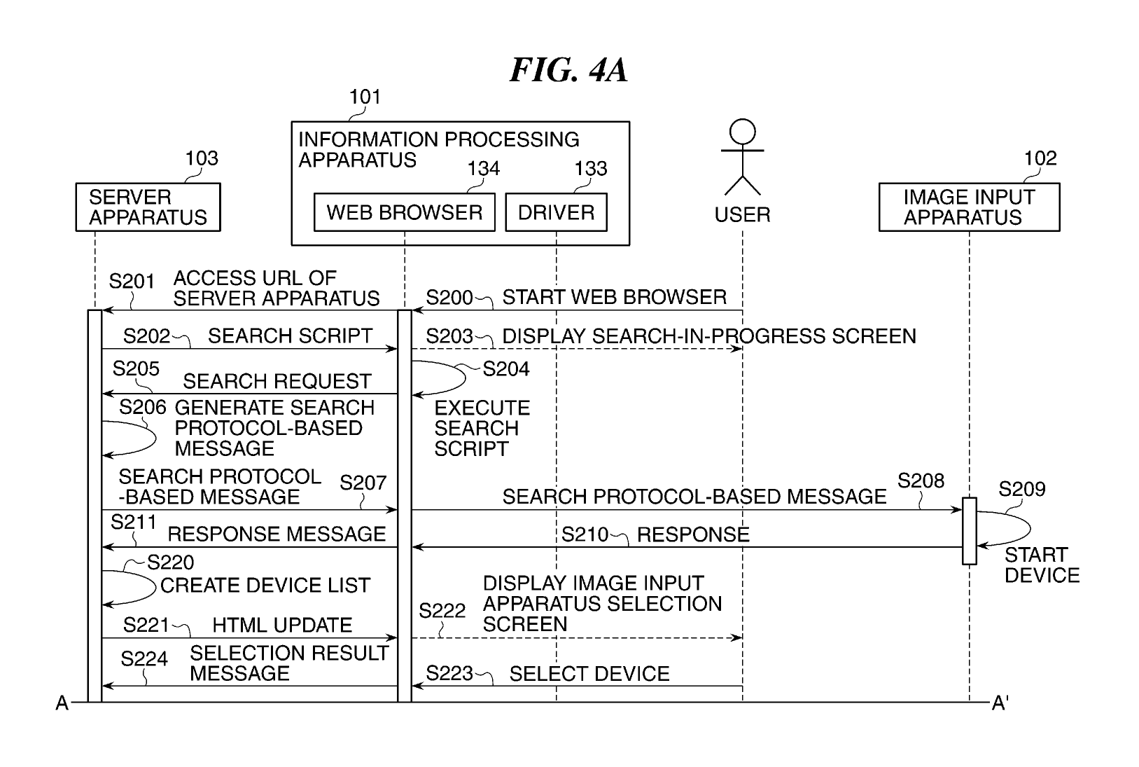

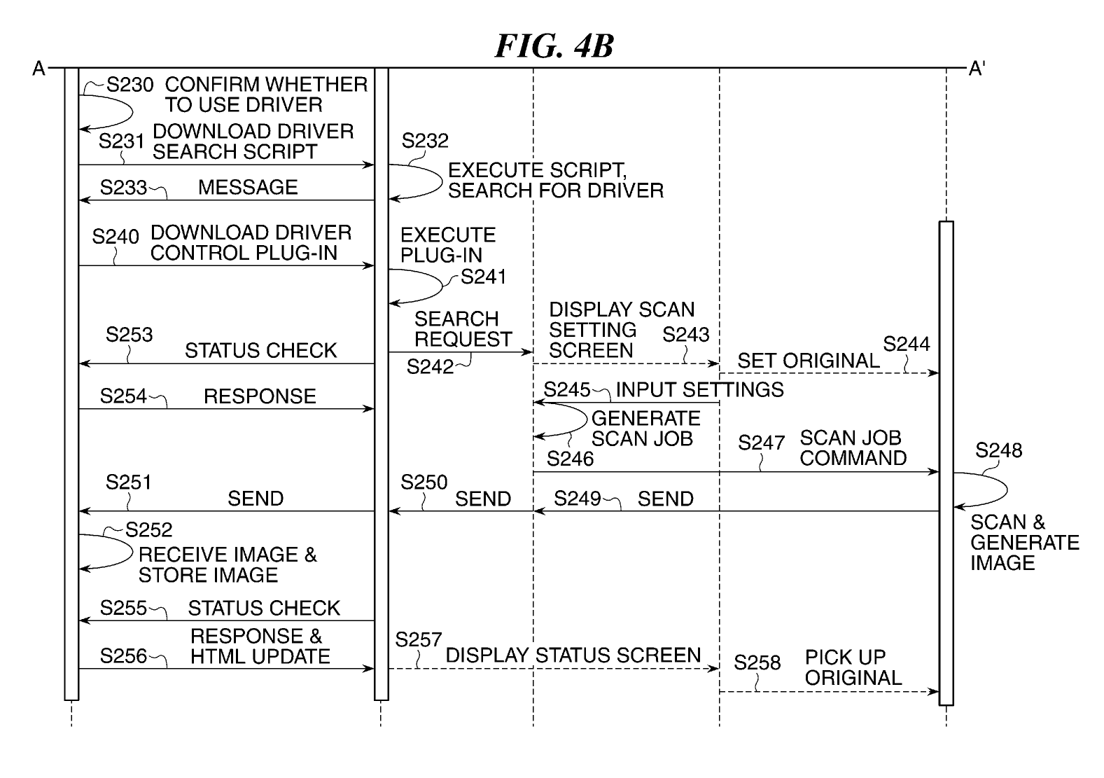

Details of an example of script execution processing by the web browser 134 will be described with reference to FIGS. 4A and 4B. Further, the driver 133 which controls a peripheral apparatus, e.g. the image input apparatus 102, is registered with the OS 131, together with information on the device to be controlled.

Next, a description will be given of the configuration of the image input apparatus 102. A CPU 202 controls the overall operation of the image input apparatus 102. A RAM 203 functions as a main memory, a work area, and so forth, for the CPU 202, and is also used as an input information-loading area and an environment data-storing area. Further, the RAM 203 has a NVRAM (nonvolatile RAM) area, and is configured to be capable of expanding a memory capacity by an option RAM connected to an expansion port, not shown.

A ROM 204 stores various types of fonts, control programs and the like executed by the CPU 202, and various kinds of data. A network interface 205 transmits and receives data to and from the information processing apparatus 101.

A printer interface 208 controls interface with a printing unit 209 which is a printer engine. A scanner interface 210 controls interface with a scanning unit 211 which is a scanner engine.

An external memory 220 stores hardware information 221. An external memory interface 212 controls access to the external memory 220, and the external memory 220 includes a flash memory, an SSD, etc. Note that when the external memory 220 is not connected, the image input apparatus 102 stores information etc. used in the information processing apparatus 101, in the ROM 204.

A console section interface 206 controls interface with a console section 207 from which the scan processing to be performed by the image input apparatus 102 is set. The console section 207 is provided with an operating panel for receiving input operations by a user. Switches, an LED display device, etc. for the input operations are arranged on the operating panel. Further, the console section 207 may include an NVRAM, not shown, to store scan setting information input from the operating panel. The above-mentioned sections are connected by a system bus 201.

With the above-described configuration, the CPU 202 acquires image data from the scanning unit 211 via the scanner interface 210 based on the control program and the like stored in the ROM 204. Further, the CPU 202 is capable of performing processing for communicating with the information processing apparatus 101 via the network interface 205. The CPU 202 is configured to be capable of transmitting image data to the information processing apparatus 101, and notifying the information processing apparatus 101 of information and the like stored in the image input apparatus 102. In the present embodiment, the network interface 205 implements a corresponding web service protocol.

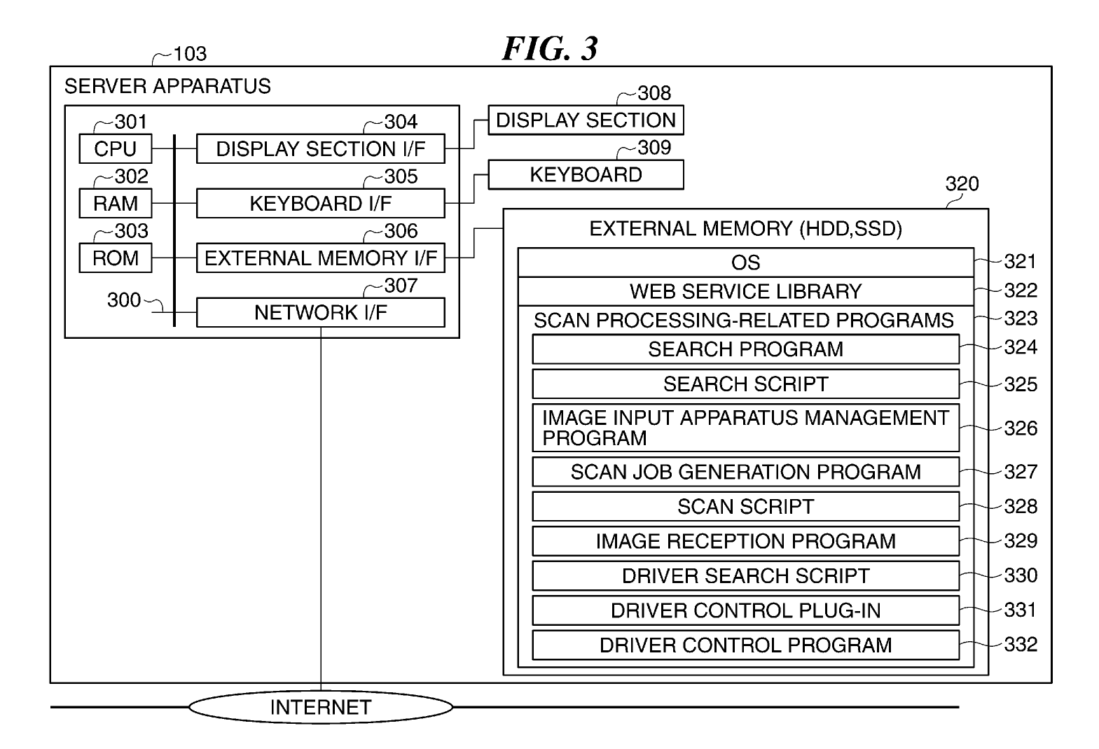

FIG. 3 is a schematic block diagram of the server apparatus 103 appearing in FIG. 1.

In FIG. 3, a CPU 301 controls the overall operation of devices connected to a system bus 300 according to a program stored in a RAM 302. The RAM 302 further functions as a main memory and a work area and the like, for the CPU 301. A ROM 303 stores various kinds of programs and data. A keyboard interface 305 controls key inputs from a keyboard 309 or a pointing device, such as a mouse, not shown.

A display section interface 304 controls contents to be displayed on a display section 308. An external memory interface 306 controls access to an external memory 320, such as a hard disk (HD) or an SSD.

The external memory 320 stores an OS 321, a web service library 322, and various kinds of scan processing-related programs 323, and further stores user files, edited files, and so on, not shown.

Of the above-mentioned stored programs and files, the scan processing-related programs 323 include a search program 324, a search script 325, an image input apparatus management program 326, a scan job generation program 327, and a scan script 328. The scan processing-related programs 323 further include an image reception program 329, a driver search script 330, a driver control plug-in 331, and a driver control program 332.

A network interface 307 is connected to the information processing apparatus 101 via the Internet 107 or the mobile communication network, and indirectly performs communication control process with the image input apparatus 102 connected to the information processing apparatus 101.

FIGS. 4A and 4B are sequence diagrams of a scanning process, including the script execution processing by the web browser 134 of the information processing apparatus 101, which is executed by the server apparatus 103, the information processing apparatus 101, and the image input apparatus 102, appearing in FIG. 1.

In FIGS. 4A and 4B, it is assumed that the web browser 134 of the information processing apparatus 101 is capable of accessing the image input apparatus 102 and the server apparatus 103 via the local network 104.

The user starts up the web browser 134 using the operating section 121 of the information processing apparatus 101 (step S200). Next, the web browser 134 accesses the URL of the server apparatus 103 to thereby log into the server apparatus 103 so as to make use of a scan processing service (step S201).

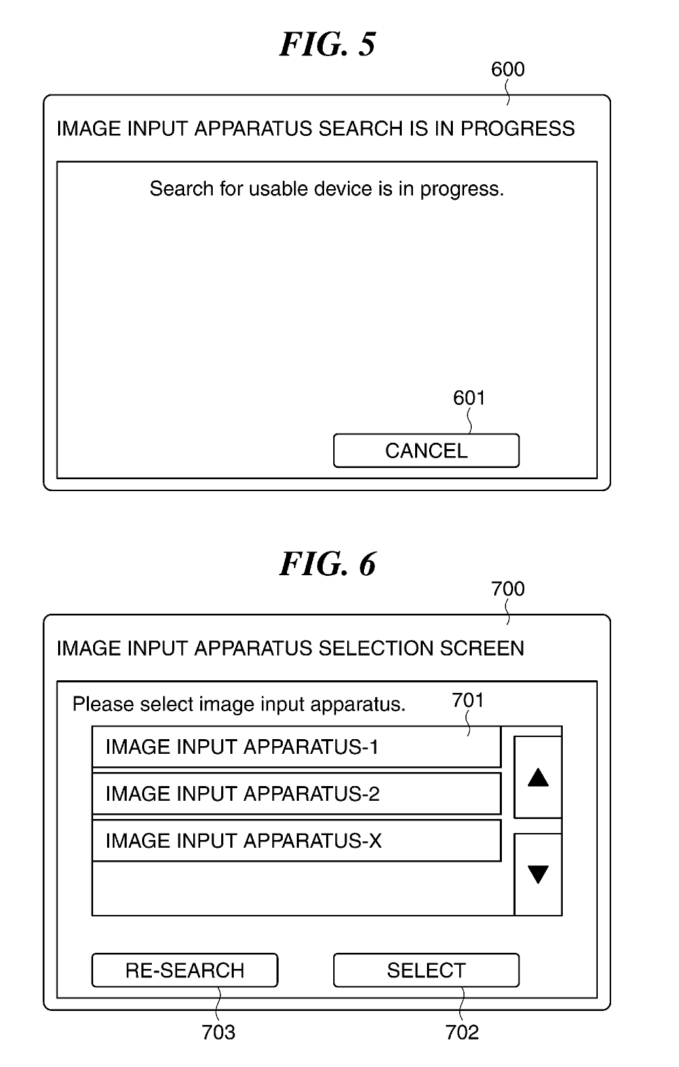

When the login is successful, a search script for a scanning system is downloaded from the server apparatus 103 to the web browser 134 (step S202). The downloaded search script is executed on the web browser 134, and the information processing apparatus 101 displays a search-in-progress screen (step S203). FIG. 5 is a view showing an example of the search-in-progress screen. Details of the search-in-progress screen in FIG. 5 will be described hereinafter.

When the search script is executed (step S204), the information processing apparatus 101 sends a search request to the server apparatus 103 (step S205). Note that although not shown, the information processing apparatus 101 periodically transmits an HTML file update request message to the server apparatus 103 during execution of the search script. By transmitting the update message, if there is a change in the status of the server apparatus 103, the information processing apparatus 101 updates the displayed screen according to the update of the HTML file.

Upon receipt of the search request, the server apparatus 103 creates a search protocol-based message (step S206). The created search protocol-based message is transmitted by the search program 324 of the server apparatus 103 to the information processing apparatus 101 (step S207). In response to this, the search script executed on the web browser 134 of the information processing apparatus 101 sends the search protocol-based message by broadcast to the local network 104 after executing IP header conversion of packet data of the received search protocol-based message (step S208). An example of the packet data conversion process executed by the search script will be described hereinafter.

Each image input apparatus 102 (denoted also as “device” in FIGS. 4A and 4B) having received the broadcast search protocol-based message is activated (returns from the sleep state) (step S209). The image input apparatus 102 determines whether or not the self device is compatible with the search protocol-based message. When it is determined that the image input apparatus 102 is compatible with the search protocol-based message, the image input apparatus 102 sends a response to the information processing apparatus 101 which is a broadcast transmission source (step S210). Thus, image input apparatuses 102 on the local network 104 which are compatible with the search protocol-based message each transmit the response back to the information processing apparatus 101.

The search script being executed on the web browser 134 of the information processing apparatus 101 having received responses converts the received responses to response messages, and sequentially transfers the response messages to the server apparatus 103 (step S211). An example of converting processing executed by the search script for converting a response to a response message will be described hereinafter.

According to this search process, further to the above, there is obtained image input apparatus information concerning the image input apparatus 102 found by the broadcast transmission of the search protocol-based message, which includes, for example, a name of the image input apparatus 102, and input capability thereof, such as supported resolutions and sheet sizes.

The method of transmitting the search protocol-based message to the local network, which can be employed in the search process is not particularly limited to the broadcast transmission mentioned above. For example, the transmission method also includes multicast transmission as used in SSDP (Simple Service Discovery Protocol) and WSD (Web Service on Devices) discovery.

Next, the image input apparatus management program 326 analyzes response messages transmitted from the information processing apparatuses 101 to the server apparatus 103, and creates a list of the retrieved image input apparatuses 102 obtained from the search result (step S220).

The image input apparatus management program 326 converts the result (list) to an HTML file, and performs the HTML update (step S221) to thereby display an image input apparatus selection screen including the list of the image input apparatuses on the web browser 134 (step S222). FIG. 6 is a view showing an example of the image input apparatus selection screen. Details of the image input apparatus selection screen shown in FIG. 6 will be described hereinafter.

The user selects the image input apparatus 102 to be used from the device list (step S223), and the web browser 134 transmits the selection result to the server apparatus (103), as a device selection message (step S224).

The driver control program 332 confirms whether or not to use a driver (step S230). For example, the confirmation is performed as follows:

When the user selects the image input apparatus to be used from the device list in the step S223, if there is a driver which can control the selected image input apparatus, the user is prompted to determine whether or not to use the driver, and information indicative of the determination result is caused to be included in the selection result message transmitted in the step S224, whereby the confirmation is performed.

Alternatively, whether to use the driver may be held in a so-called cookie as information. Further, there may be employed the following confirmation method: User information is stored in the server apparatus 103, and information on determination of whether or not to use the driver is stored in association with each user in the user information, so as to perform the determination when the user has logged into the server apparatus 103 in the step S201.

When it is confirmed by one of the above-mentioned methods in the step S230 that the driver is to be used, the process proceeds to a step S231.

On the other hand, when it is confirmed that the driver is not to be used, although not shown in detail, the following processing is performed. The web browser 134 of the information processing apparatus 101 controls the image input apparatus 102 according to the scan script 328 and the scan job transmitted from the scan job generation program 327 of the server apparatus 103.

Then, the image data transmitted from the image input apparatus 102 is transferred to the server apparatus 103. The image data is transferred without modifying the contents of the image data by performing processing for IP header conversion of packet data, similarly to the operation executed by the search script 325 in the step S211.

In the step S231, the web browser 134 downloads the driver search script 330, whereby the driver search script 330 is executed (step S232).

The driver search script 330 is formed as a program which performs the following processing: Using a driver control interface, such as a Windows (registered trademark) Imaging Acquisition (hereinafter referred to as the “WIA”) interface which has been set up in the Windows (registered trademark) OS 131, information on the driver 133 registered in the OS 131 is searched for.

When the driver 133 is found by the search, it is determined whether or not the driver 133 is usable in the image input apparatus 102 selected in the step S224 by comparing the device information, such as the name of the image input apparatus 102, and an ID uniquely defined for each image input apparatus 102.

As a result, whether or not the driver 133 exists which is usable in the selected image input apparatus 102 is returned as a message (step S233). If the usable driver 133 exists in the step S233, the process proceeds to a step S240. Then, the web browser 134 downloads the driver control plug-in 331 (step S240).

If the usable driver 133 does not exist in the step S233, although not shown in detail, the following processing is performed: The web browser 134 of the information processing apparatus 101 controls the image input apparatus 102 according to the scan script/scan job transmitted from the server apparatus 103. The information processing apparatus 101 transfers the image data transmitted from the image input apparatus 102 to the server apparatus 103.

In the step S241, the downloaded driver control plug-in 331 is executed. The steps S240 and S241 may be executed using any suitable method, such as the ActiveX control, the Java (registered trademark) script, the Java (registered trademark) applet, or any of various types of plug-ins, insofar as it can be executed by the information processing apparatus 101.

The driver 133 is started by the executed driver control plug-in 331 (step S242). The start and control of the driver 133 are performed using a driver control interface, such as the WIA interface, similarly to the step S232.

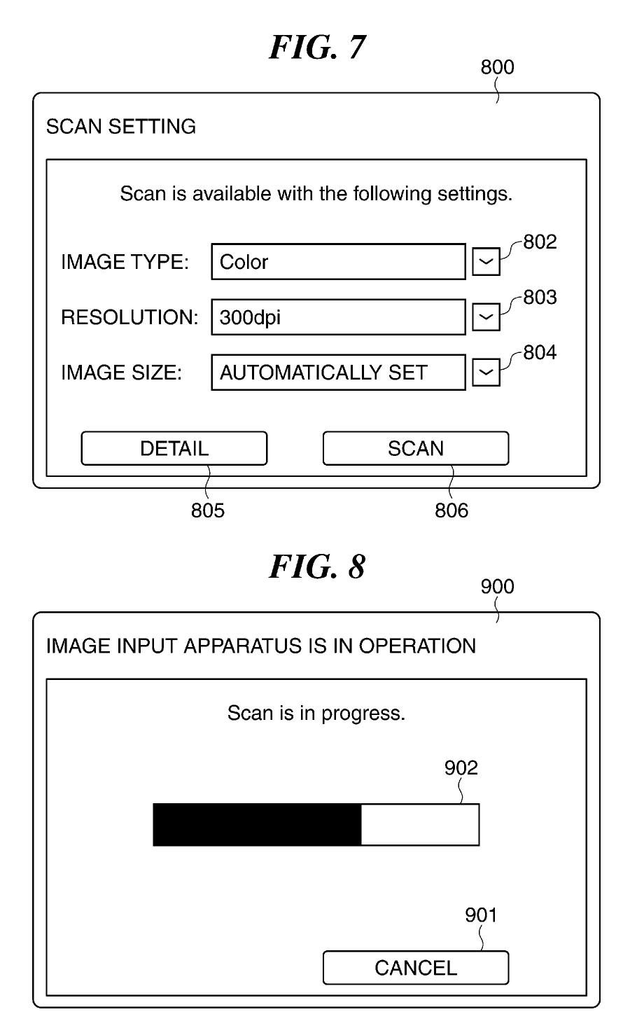

The started driver 133 displays a scan setting screen for configuring scan settings (step S243). FIG. 7 is a view showing an example of the scan setting screen. Details of the scan setting screen shown in FIG. 7 will be described hereinafter.

The user sets an original on the image input apparatus 102 selected in the image input apparatus selection screen shown in FIG. 6 (step S244), and inputs settings for scanning from the scan setting screen shown in FIG. 7 (step S245).

When execution of the scanning is instructed, the driver 133 generates a scan job based on the setting information input in the step S245 (step S246), and sends a scan job command to the image input apparatus 102 (step S247).

The image input apparatus 102 executes the scanning operation according to the scan job command to generate an image (step S248), and transmits the generated image data to the driver 133 (step S249). A scan-in-progress screen is displayed after the scanning operation is started until the image data is stored. FIG. 8 is a view showing an example of the scan-in-progress screen. Details of the scan-in-progress screen shown in FIG. 8 will be described hereinafter.

The driver 133 transfers the received image data to the driver control plug-in 331 via the driver control interface, similarly to the step S242 (step S250).

The driver control plug-in 331 transmits the received image data to the server apparatus 103 (step S251). Then, the server apparatus 103 receives the image data, and after performing proper image conversion processing on the image data, the server apparatus 103 stores the final image data (step S252).

A method for transmitting image data from the driver control plug-in 331 to the server apparatus 103 is not particularly limited, but a protocol which can transmit and receive image data, such as SMB (Server Message Block) or WebDAV (Web-based Distributed Authoring and Versioning), may be used. Further, there may be employed a method in which the image data is transferred without modifying the contents of the image data by performing processing for IP header conversion of packet data, similarly to the operation executed by the search script 325 in the step S211.

On the other hand, the driver control plug-in 331 sends a notification of session maintaining after the driver has been started in the step S242 so as to prevent the server apparatus 103 from terminating the session due to time-out. By periodically transmitting a status check message to the server apparatus 103 (S253), the server apparatus 103 maintains the session.

When there is a change in the status of the server apparatus 103, processing coping with the change is performed by the HTML file update. Therefore, when the image storage processing is terminated in the step S252, in response to the status check message sent from the driver 133 (step S255), the server apparatus 103 transmits an updated HTML file as a response to the status check.

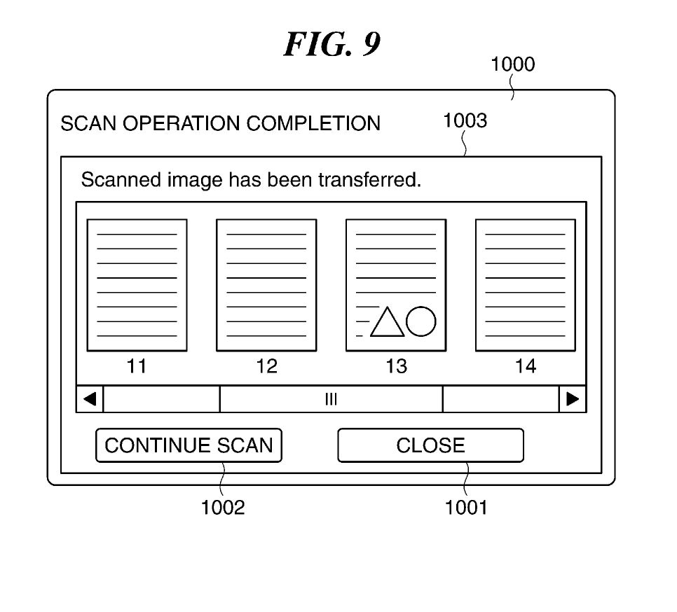

Then, the web browser 134 displays a screen of scan termination notification (step S257). FIG. 9 is a view showing an example of the scan operation completion screen. Details of the scan operation completion screen shown in FIG. 9 will be described hereinafter.

The user goes and picks up the original on which the operation has been completed from the image input apparatus 102 (step S258), followed by terminating the present process.

According to the above scan processing sequence, the image data obtained by scanning the original is stored in the server apparatus 103.

The screens in FIGS. 5 to 9 referred to in the above description will be described in detail.

The search-in-progress screen, denoted by reference numeral 600, shown in FIG. 5, is a screen displaying the HTML file which has been updated by the server apparatus 103, in a state in which the search script is being executed in the step S303. If a cancel button 601 is depressed by the user, the search script sends a cancel message to the server apparatus 103, whereby the search process is aborted.

The image input device selection screen, denoted by reference numeral 700 in FIG. 6, is a screen which the web browser 134 displays based on the HTML file updated by the image input apparatus management program 326 of the server apparatus 103 in the step S305 (image input device selection screen HTML).

In an image input apparatus list display section 701, when the user depresses a selection button 702, the search script sends a selection result message to the server apparatus 103. The server apparatus 103 confirms whether or not to use the driver 133, and prepares the scan script 328 compatible with the selected image input apparatus 102.

When the user depresses a re-search button 703, a search request is sent to the server apparatus 103 as a message again, and the steps S206 to S222 are executed again. As a result, the contents of the image input apparatus list display section 701 are updated.

The scan setting screen, denoted by reference numeral 800 in FIG. 7, is a screen for enabling the user to select settings of the scan processing.

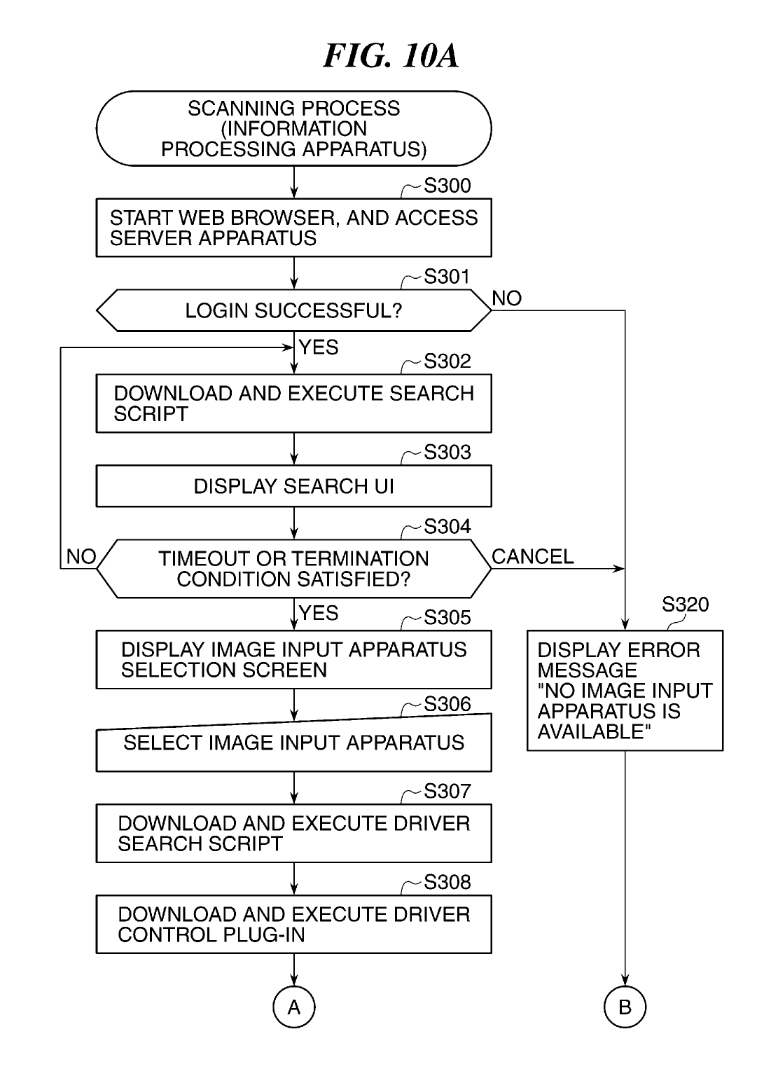

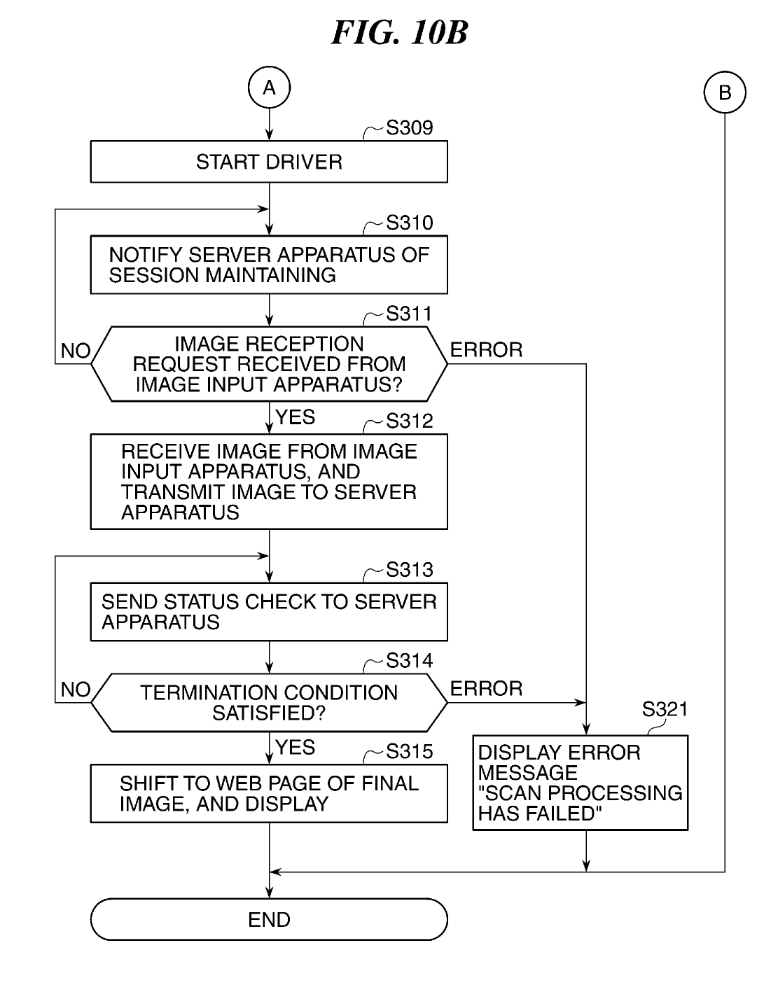

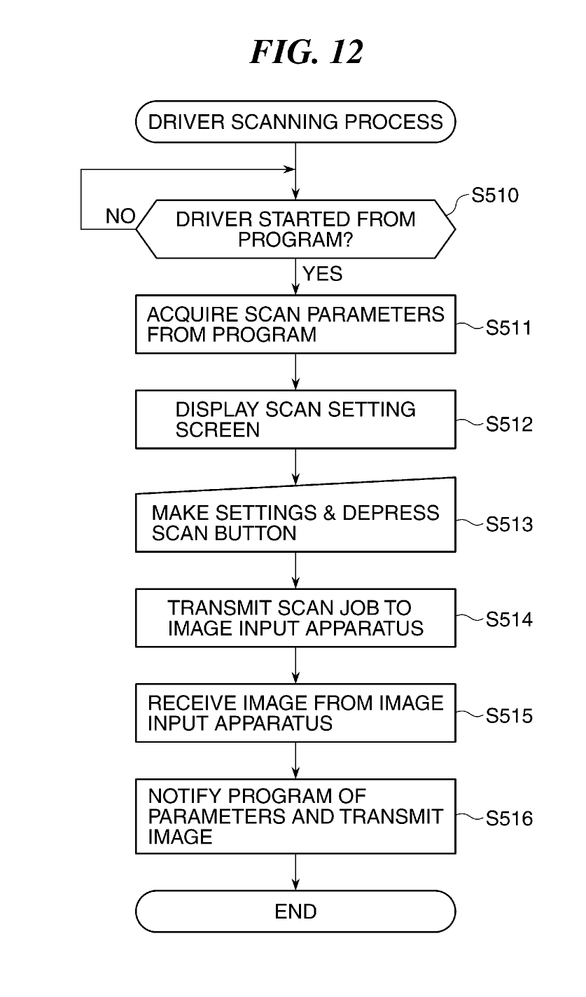

The scan setting screen 800 is displayed by the driver control plug-in 331 in a step S308 in FIG. 10A, referred to hereinafter, or by the driver in a step S512, referred to hereinafter, in FIG. 12.

On the scan setting screen 800, there are displayed an image type drop-down combo box 802, a resolution drop-down combo box 803, and an image size drop-down combo box 804, for configuring settings of the scanning operation. Also displayed on the scan setting screen 800 are a detail button 805 and a scan button 806.

The image type drop-down combo box 802 is used for designating a color-related mode in scanning, i.e. for designating monochrome, color, or gray scale. The resolution drop-down combo box 803 is used for designating resolution in scanning. The resolution is designated by selecting a desired one of resolution values displayed in a list, or directly inputting a resolution value entered by the user.

The image size drop-down combo box 804 is used for designating an image size in scanning. In the present embodiment, it is possible to designate a regular size, such as A4 and Legal, or automatic designation which automatically determines a size using a detection sensor or the like. The scan button 806 is used by the user, for instructing execution of scanning. When the present screen is being displayed by the driver control plug-in 331 in the step S308 in FIG. 10A, described hereinafter, the driver 133 is started by depressing the scan button 806.

When the user depresses the scan button 806, the scan script 328 transmits the settings configured from the buttons 801 to 804 at the time to the server apparatus 103 as a setting message.

The detail button 805 is a button which is depressed by the user, for making more detailed settings. This makes it possible to make settings e.g. for high-level image processing. Although not shown, the scan setting screen 800 may have not only the above-mentioned boxes, but also a web service selection drop-down combo box for designating a storage location of scanned image data. In this case, a storage location can be designated e.g. by directly inputting a URL by which a storage location can be identified, searching for a service having a function of storing image data from the Web, or selecting a desired storage location from history.

The scan-in-progress screen, denoted by reference numeral 900 in FIG. 8, will be described. This screen is displayed by the driver 133 after the image input apparatus 102 starts the scan operation in the step S248 in FIG. 4B until the scanned image data is stored in the server apparatus s103.

A cancel button 901 is used for canceling the scan processing being executed. When the cancel button 901 is depressed, the driver 133 transmits a cancel message to the image input apparatus 102, similarly to the step S247.

A scan processing progress indicator 902 indicates the progress of scan processing in the step S248 and image data transmission processing in the step S249, and notifies the user of the status of the scan processing and image data transmission processing.

The scan operation completion screen, denoted by reference numeral 1000 in FIG. 9, will be described. When image data reception is completed in the image storage processing in the step S252, the image reception program 329 creates an HTML file including a reduced image which can be displayed on the information processing apparatus 101, from the image data. Then, the HTML file is transmitted to the web browser 134 of the information processing apparatus 101, whereby the scan operation completion screen 1000 is displayed to notify the user of the operation completion.

A reduced image display area 1003 is displayed on the scan operation completion screen 1000 to notify the user of the contents of the final scanned image. When the user depresses a close button 1001, the scan operation completion screen 1000 is closed, whereby the programs of the scan script 328, etc. downloaded and executed by the web browser 134 are terminated. When the user depresses a continue-scan button 1002, the process returns to the step S242, wherein the scan setting screen 800 shown in FIG. 7 is displayed.

FIGS. 10A and 10B are a flowchart of a scanning process executed by the information processing apparatus 101 appearing in FIG. 1.

In FIGS. 10A and 10B, the information processing apparatus 101 starts up the web browser 134 by the OS 131, and accesses the URL of the server apparatus 103 (step S300). The information processing apparatus 101 logs into a web page hosted by the web service library 322 of the server apparatus 103, and determines whether or not the login is successful (step S301).

If the login is not successful (NO to the step S301), the web browser 134 displays an error message of “No image input apparatus is available.” (step S320), followed by terminating the present process.

If the login is successful (YES to the step S301), the web browser 134 downloads the search script 325 from the server apparatus 103 via the Internet 107, and executes the downloaded search script 325 (step S302).

When the search script 325 is executed, a search request message is sent to the server apparatus 103, and then the search script 325 receives a search protocol-based message as a response to the search request. Then, the search script 325 performs IP header conversion of each network packet of the search protocol-based message to thereby transmit the search protocol-based message to the local network by broadcast. The search script 325 transfers each of responses sent back from the image input apparatuses 102a and 102b and the like in response to the search protocol-based message sent thereto by broadcast, to the server apparatus 103 as a response message after performing IP header conversion of the network packets of the response.

During execution of the above-mentioned search script, the web browser 134 displays the search-in-progress screen shown in FIG. 5 (step S303). The step S303 corresponds to an operation of a selection screen display unit that displays a selection screen for prompting the user to select an image input apparatus to be operated, from a list of image input apparatuses found by a search by a server apparatus.

Next, it is determined whether or not session time-out occurs or a termination condition is satisfied (step S304). The time-out means that a predetermined time period set for polling processing has timed out. Further, the termination condition is that the HTML file is updated by the server apparatus 103.

If neither session time-out occurs nor satisfaction of the termination condition occurs (NO to the step S304), the process returns to the step S302. At this time, if the processing is canceled by the user, the process proceeds to the step S320.

If session time-out occurs or and the termination condition is satisfied (YES to the step S304), the update of the HTML file is performed by the server apparatus 103, and the web browser 134 displays the image input apparatus selection screen shown in FIG. 6 (step S305).

When the user selects the image input apparatus to be used from the device list (step S306), the server apparatus 103 is notified of a selection result message. The step S306 corresponds to an operation of a selection result transmission unit that transmits a selection result indicative of an image input apparatus selected by the user.

In this search process, the web browser 134 further acquires the following image input apparatus information on each image input apparatus 102 found by the broadcast transmission: The information includes e.g. a name of the image input apparatus 102, and input capability thereof, such as supported resolutions and sheet sizes.

Then, the driver search script is downloaded from the server apparatus 103, and is executed by the web browser 134 of the information processing apparatus 101 (step S307). The contents of the downloaded script are different depending on the result of the confirmation in the step S230 in FIG. 4B. In a case where it is confirmed in the step S230 that the driver is to be used, the driver search script 330 is downloaded from the server apparatus 103 in the step S307. The step S307 corresponds to an operation of a first acquisition unit that acquires a search script for searching the information processing apparatus for a driver for using an image input apparatus indicated by a selection result.

In a case where it is confirmed that the driver 133 is not to be used, although not shown in detail, the web browser 134 of the information processing apparatus 101 controls the image input apparatus 102. As a consequence, the scan script 328 for transferring the image data transmitted from the image input apparatus 102 to the server apparatus 103 is downloaded. In the present embodiment, the former case will be described.

In the step S307, the downloaded driver search script is executed. The driver search script 330 is formed as a program which performs the following processing: Assuming that the OS 131 is the Windows (registered trademark), using a driver control interface, such as the WIA interface, information on the driver 133 registered in the OS 131 is searched for.

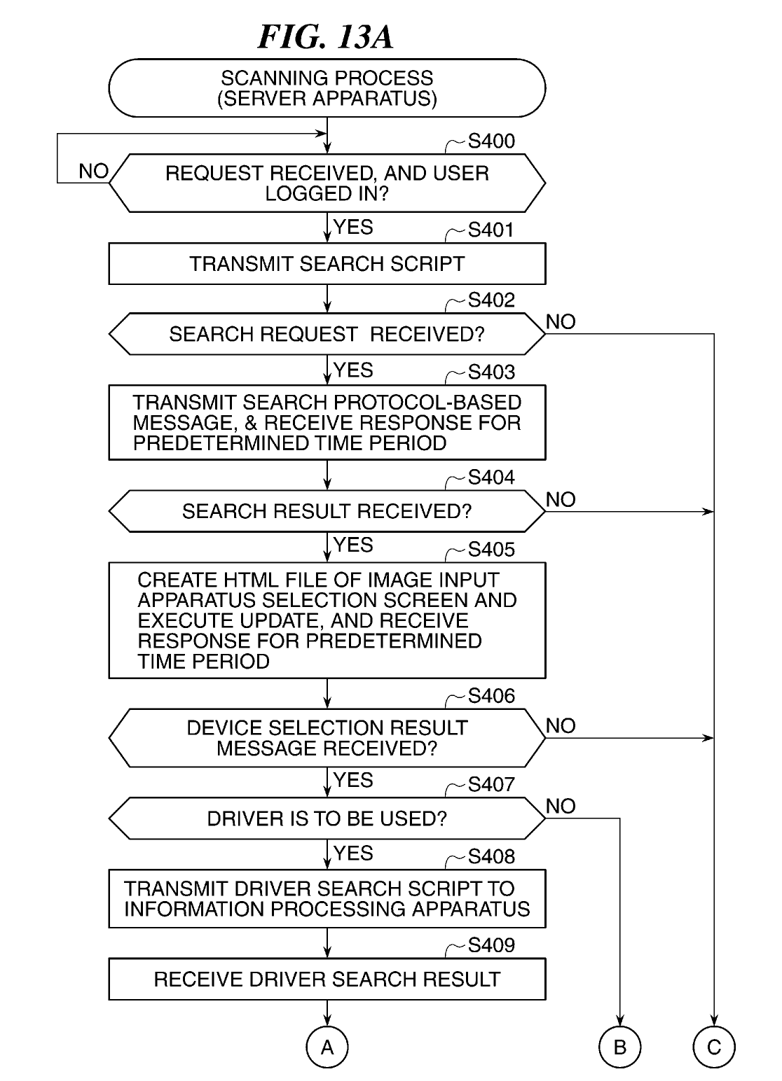

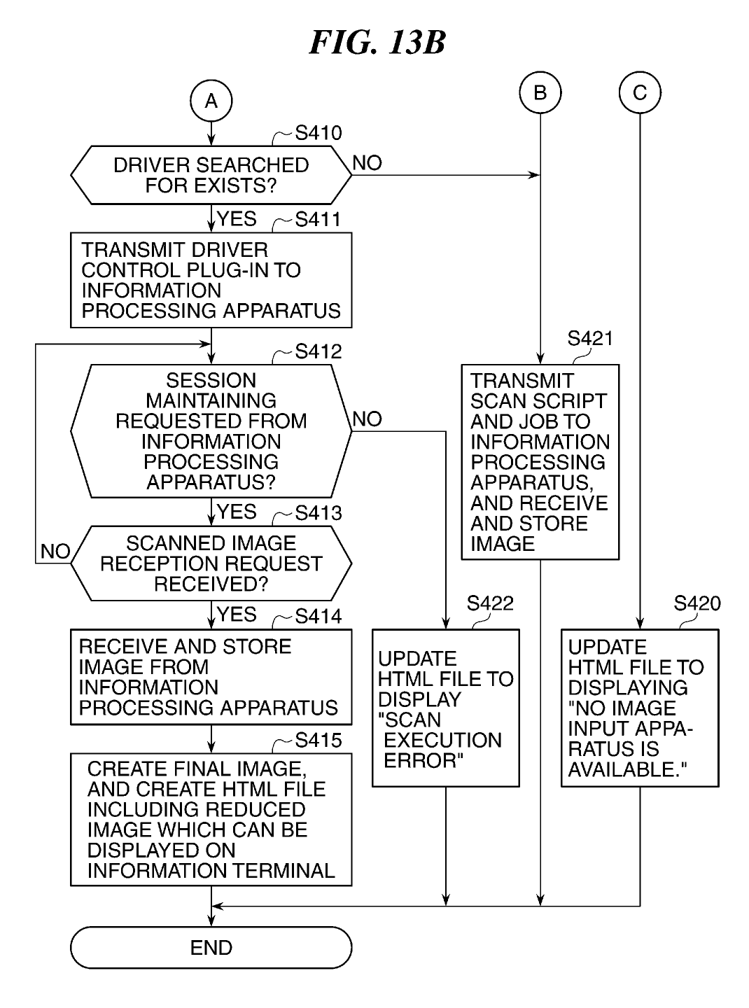

Then, the information on the driver 133 found by the search is directly transferred to the server apparatus 103. Then, the server apparatus 103 determines a program to be downloaded based on the result of the search in the step S307, and transmits the program to the web browser 134 of the information processing apparatus 101. The determination processing performed by the server apparatus 103 will be described in detail with reference to FIGS. 13A and 13B.

In the present example, it is determined that the driver can be used in the selected image input apparatus 102, and the driver control plug-in 331 is downloaded from the server apparatus 103, and is executed (step S308). The driver control plug-in 331 may be executed using any suitable method, such as the ActiveX control, the Java (registered trademark) script, the Java (registered trademark) applet, or any of various types of plug-ins, insofar as it can be executed by the information processing apparatus 101. The step S308 corresponds to an operation of a second acquisition unit that acquires a driver control program for controlling a driver from a sever apparatus when it is determined by a search script that the driver exists in the information processing apparatus.

When the driver control plug-in 331 is executed, the driver 133 is started via the driver control interface, such as a WIA interface, similarly to the step S307 (step S309). Alternatively, the start of the driver 133 may be performed such that the scan setting screen shown in FIG. 7 is displayed before starting the driver 133, and when execution of the scan is instructed from the user via the screen, the driver 133 is started. Therefore, the step S309 corresponds to an operation of a display unit that displays a setting screen for setting a detailed operation of an image input apparatus by a driver started by a driver control program. Further, since the driver is started to control the image input apparatus 102, the step S309 corresponds to an operation of a control unit that controls an image input apparatus by transmitting a job command indicative of a detailed operation set by the user to the image input apparatus.

When the driver is started, the web browser 134 of the information processing apparatus 101 sends a notification of session maintaining to the server apparatus 103 so as to prevent the server apparatus 103 from terminating the session due to time-out (step S310). More specifically, by periodically transmitting an HTML file update request message to the server apparatus 103, the web browser 134 of the information processing apparatus 101 causes the server apparatus 103 to maintain the session.

Subsequently, it is determined whether or not the driver 133 has received an image reception request from the image input apparatus 102 (step S311). If it is determined in the step S311 that no image reception request has been received (NO to the step S311), the process returns to the step S310. On the other hand, if a cancel notification or an error notification is received, the driver control plug-in 331 causes the web browser 134 to display an error message of “Scan processing has failed.” (step S321), followed by terminating the present process.

If the driver 133 has received an image reception request from the image input apparatus 102 (YES to the step S311), image data is received via the driver control interface, such as the WIA interface, similarly to the step S309, and transfers the received image data to the server apparatus 103 (step S312). The method for transmitting image data is not particularly limited, but there may be employed a protocol which can transmit and receive image data, such as SMB or WebDAV, or a method in which the image data is transferred without modifying the contents of the image data by performing processing for IP header conversion of packet data, similarly to the operation executed by the search script 325.

Subsequently, the web browser 134 sends the status check message to the server apparatus 103 (step S313). Then, the server apparatus 103 determines whether or not the image storage processing by the server apparatus 103 is terminated, or a predetermined time period set for image data reception has timed out, and the HTML file is updated or not updated depending on the result of the determination. Then, it is determined whether or not the web browser 134 has received the updated HTML file to thereby determine whether or not the termination condition is satisfied (step S314). If the termination condition is not satisfied (NO to the step S314), the process returns to the step S313, and if a condition e.g. for cancellation occurs, the process proceeds to the step S321.

If it is determined in the step S314 that the termination condition is satisfied (YES to the step S314), the scan operation completion screen shown in FIG. 9 as a web page of the final image is displayed on the web browser 134. This indicates that the image data scanned by the user has been stored in the server apparatus 103, followed by terminating the scanning process executed by the web browser 134 of the information processing apparatus 101 in the present embodiment.

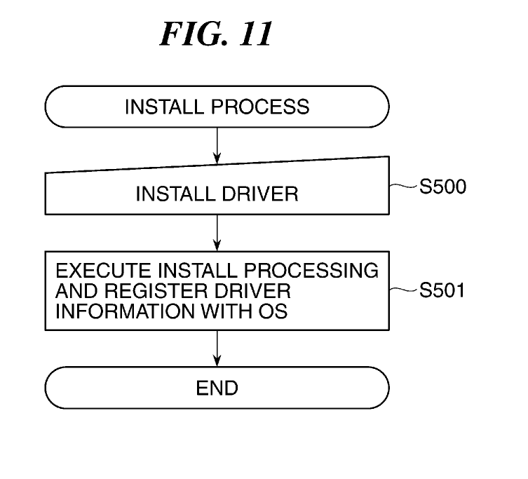

FIG. 11 is a flowchart of an installation process executed by the information processing apparatus 101 appearing in FIG. 1.

In FIG. 11, when the driver 133 is installed by the user (step S500), a file necessary for the driver 133 is integrated in the OS 131, and the driver information is registered with the OS 131 as a driver program (step S501), followed by terminating the present process.

FIG. 12 is a flowchart of a driver scanning process executed by the information processing apparatus 101 appearing in FIG. 1.

In FIG. 12, it is determined whether or not the driver 133 installed by the installation process has been started from a program as a controller (control source) (step S510). Communication between the program as the controller and the driver 133, including the start of the driver 133, is performed via a driver control interface, such as the WIA interface.

Further, any suitable program can be applied to the controller program insofar as it uses a driver control interface. For example, any of various kinds of image input applications, Java (registered trademark) scripts, Java (registered trademark) applets, or any of various types of plug-ins, insofar as it uses the driver control interface. In the present embodiment, the controller program is the driver control plug-in 331.

If the driver 133 has been started from the program (YES to the step S510), the driver 133 acquires scan parameters for creating a scan job from the driver control plug-in 331 (step S511), and displays the scan setting screen shown in FIG. 7.

The scan setting screen may be displayed not by the driver 133, but by the driver control plug-in 331. Next, the settings for scanning are made by the user, and the scan button 806 is depressed (step S513). With this operation, a scan job is generated, and is transmitted to the image input apparatus 102 (step S514).

Then, the driver 133 receives the image data from the image input apparatus 102 (step S515), notifies the program of the parameters, and further transmits the image data (step S516), followed by terminating the present process.

FIGS. 13A and 13B are a flowchart of a scanning process executed by the server apparatus 103 appearing in FIG. 1.

In FIGS. 13A and 13B, when the server apparatus 103 receives a request message from the information processing apparatus 101, and the user logs into the server apparatus 103 (YES to a step S400), the server apparatus 103 transmits the search script 325 (step S401).

Subsequently, it is determined whether or not a search request by a search request message has been received from the information processing apparatus 101 within a predetermined time period (step S402). If no search request has been received within the predetermined time period (NO to the step S402), the search program 324 updates the HTML file to one for displaying a message “No image input apparatus is available.” which implies that an environment for scan processing cannot be created (step S420), and causes the web browser 134 to display the message, followed by terminating the present process. This is performed by the search program 324 as a response to the HTML file update request message, by making use of the search script performing periodical transmission of the HTML file update request message to the server apparatus 103.

On the other hand, if a search request has been received within the predetermined time period (YES to the step S402), the search program 324 sends a search protocol-based message to the information processing apparatus 101, and waits and receives to analyze responses for a predetermined time period (step S403).

Then, it is determined whether or not a search result has been received within a predetermined time period (step S404). If it is determined in the step S404 that no search result has been received (NO to the step S404), the process proceeds to the step S420.

On the other hand, if it is determined in the step S404 that a search result has been received (YES to the step S404), the image input apparatus management program 326 creates an HTML file for showing the image input apparatus selection screen. The server apparatus 103 causes the web browser 134 to display the image input apparatus selection screen, and waits and receives a response from the user for a predetermined time period (step S405). The step S405 corresponds to an operation of a list providing unit that provides a list of image input apparatuses found by a search to the information processing apparatus.

Then, it is determined whether or not a device selection result message has been received within a predetermined time period (step S406). If it is determined in the step S406 that no device selection result message has been received (NO to the step S406), the process proceeds to the step S420.

On the other hand, if a device selection result message has been received (YES to the step S406), it is determined whether or not the driver is to be used (step S407). The method of this determination unit includes the following: When the user selects the image input apparatus to be used from the device list in the step S223 in FIG. 4A, if there is a driver which can control the selected image input apparatus, the user is prompted to determine whether or not to use the driver, and information indicative of the determination result is caused to be included in the selection result message, for the determination. Alternatively, whether to use the driver may be held in a so-called cookie as information. Further, there may be employed the following method: User information is stored in the server apparatus 103, and information on determination of whether or not to use the driver is stored in association with each user in the user information, so as to perform the determination when the user has logged into the server apparatus 103 in the step S400.

If it is determined in the step S407 that the driver is not to be used (NO to the step S407), transmission of the scan script 328 and a scan job to the information processing apparatus 101, and image reception and storage are performed (step S421), followed by terminating the present process. In the step S421, although not shown in detail, the following processing is performed: The web browser 134 of the information processing apparatus 101 controls the image input apparatus 102 according to the scan script 328 and the scan job transmitted from the scan job generation program 327 of the server apparatus 103. Then, the web browser 134 transfers the image data transmitted from the image input apparatus 102 to the server apparatus 103. For the transmission of image data, there may be employed a method in which the image data is transferred without modifying the contents of the image data by performing processing for IP header conversion of packet data, similarly to the operation executed by the search script in the step S401. As described above, when it is determined by the search script that the driver does not exist or the driver is not to be used, control script information for controlling the image input apparatus 102 selected by the information processing apparatus 101 is provided to the information processing apparatus 101.

If it is determined in the step S407, that the driver is to be used (YES to the step S407), the driver control program 332 transmits the driver search script 330 to the web browser 134 of the information processing apparatus 101 (step S408). The step S408 corresponds to an operation of a search script providing unit that provides a search script to the information processing apparatus for searching whether or not a driver for using the image input apparatus exists in the information processing apparatus.

Then, the server apparatus 103 receives the result of execution of the driver search script 330 from the information processing apparatus (step S409).

Then, it is determined whether or not there is a driver which can be used for the selected image input apparatus 102 received in the step S406 (step S410). The method of this determination includes the following: Information on the driver 133 received in the step S409 is compared with the name of the image input apparatus 102 received in the step S406 and the ID information which is uniquely defined for each type of the image input apparatus 102 to thereby determine whether or not there is a driver which can be used. Note that the information on the driver 133 includes e.g. the name of the image input apparatus to be controlled by the driver, and the ID information which is uniquely defined for each type of the image input apparatus to be controlled.

If it is determined in the step S410 that there is no driver which can be used (NO to the step S410), the process proceeds to the step S421. On the other hand, if there is a driver which can be used (YES to the step S410), the driver control plug-in 331 is transmitted to the web browser 134 of the information processing apparatus 101 (step S411). The driver control plug-in 331 may be executed by any suitable method, such as the ActiveX control, the Java (registered trademark) script, the Java (registered trademark) applet, or any of various types of plug-ins, insofar as it can be executed by the information processing apparatus 101. The step S411 corresponds to an operation of a program providing unit that provides a driver control program for controlling a driver to the information processing apparatus when it is determined by a search script that a driver exists in the information processing apparatus.

Then, it is determined whether or not a session maintaining request in the form of a status check message has been received from the information processing apparatus 101 (step S412). If it is determined in the step S412 that time-out has occurred and no session maintaining request has been received (NO to the step S412), the driver control program 332 creates an HTML file for displaying “Scan execution error” to thereby update the HTML file. Then, the web browser 134 is caused to display the updated HTML file (step S422), followed by terminating the present process. The scan execution error implies that a scan execution processing environment cannot be created.

If a session maintaining request, i.e. a status check message has been received (YES to the step S412), it is determined whether or not a request for receiving a scanned image has been received from the information processing apparatus 101 (step S413). If it is determined in the step S413 that no reception request has been received (NO to the step S413), the process returns to the step S412. If a reception request has been received (YES to the step S413), the server apparatus 103 receives the image data from the information processing apparatus 101, and stores the same (step S414). The method of this reception is not particularly limited, but there may be employed a protocol which can transmit and receive image data, such as SMB or WebDAV, or a method in which the image data is transferred without modifying the contents of the image data by performing processing for IP header conversion of packet data, similarly to the operation executed by the search script 325. The step S414 corresponds to an operation of a storage unit that acquires image data via the information processing apparatus, which is input from an image input apparatus by a driver controlled by a driver control program, and stores the acquired image data.

Then, the server apparatus 103 creates an HTML file including a reduced image which can be displayed on the information processing apparatus 101, and causes the information processing apparatus 101 to display the scan operation completion screen shown in FIG. 9 (step S415), followed by terminating the present process.

According to the process in FIGS. 13A and 13B, when it is determined that there is a driver in the information processing apparatus 101, the server apparatus 103 provides a driver control program for controlling the driver to the information processing apparatus 101. As a result, when using an image input service provided by the server apparatus on the network, it is possible to make effective use of the driver function existing in the information processing apparatus.

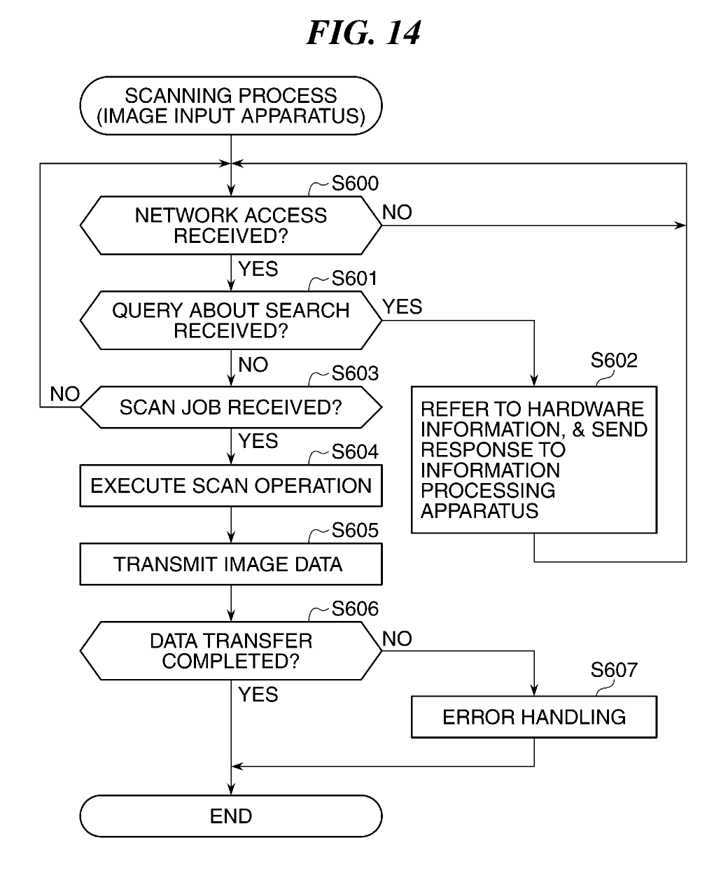

FIG. 14 is a flowchart of a scanning process executed by the image input apparatus 102 appearing in FIG. 1.

In FIG. 14, the image input apparatus 102 waits for access to the network interface 205 from the outside via the local network 104. When the image input apparatus 102 has a network access in this state (YES to a step S600), the image input apparatus 102 is activated (returns from the sleep state), and it is determined whether or not a query about the search by a search command is received (step S601).

If it is determined in the step S601 that a query about the search has been received (YES to the step S601), the image input apparatus 102 refers to the hardware information 221 stored in the external memory 220. Then, the image input apparatus 102 sends a response to the information processing apparatus 101 (step S602), and the process returns to the step S600. The hardware information includes e.g. a name of the image input apparatus 102 and input performance information on the image input apparatus 102, such as supported resolutions and sheet sizes.

On the other hand, if it is determined in the step S601 that no query about the search has been received (NO to the step S601), it is determined whether or not a scan job has been received from the information processing apparatus 101 (step S603). If it is determined in the step S603 that no scan job has been received (NO to the step S603), the process returns to the step S600.

On the other hand, if it is determined in the step S603 that a scan job has been received (YES to the step S603), the image input apparatus 102 performs the scan operation in the step S248 in FIG. 4B according to the scan job sent from the access source (step S604).

Then, the image input apparatus 102 transmits the image data generated by the scan operation to the access source (step S605).

Then, it is determined whether or not the data transfer of the image data is completed by a termination command from the access source (step S606). If it is determined in the step S606 that the data transfer is not completed (NO to the step S606), the image input apparatus 102 performs error handling (step S607), followed by terminating the present process. In the step S606, if no termination command indicative of completion of data transfer has been received within a predetermined time period, it is judged that time-out has occurred and it is determined that the data transfer is not completed. If it is determined in the step S606 that the data transfer is completed, the present process is terminated.

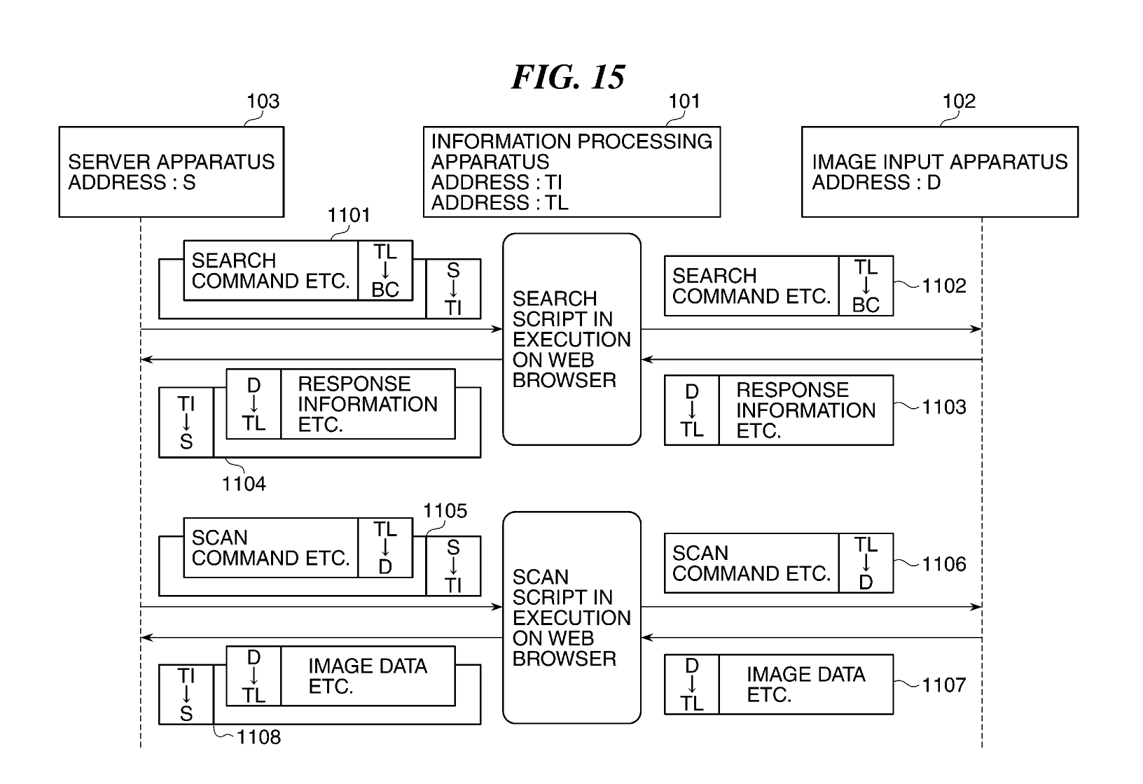

FIG. 15 is a diagram showing an example of the contents of data which are transmitted and received, and processing of data transmission and reception performed by the search script 325 and the scan script 328 when the search script 325 and the scan script 328 of the server apparatus 103 are executed by the web browser 134 of the information processing apparatus 101.

In FIG. 15, first, a description will be given of a network address. An address of the server apparatus 103 connected to the Internet 107 via the network interface 307 is represented by S. A network address of the information processing apparatus 101 in the network 106 for connecting to the server apparatus via the Internet 107 connected via the first communication interface 114 is represented by TI. A network address of the information processing apparatus 101 used when the second communication interface 119 is connected to the local network 104 is represented by TL. A network address of the image input apparatus 102 used when the image input apparatus 102 is connected to the local network 104 via the network interface 205 is represented by D.

Next, a description will be given of a representative example of data transmitted and received by the scripts. Data 1101 is an example of data transmitted as a search protocol-based message from the server apparatus 103 to the search script being executed by the web browser 134 of the information processing apparatus 101 in the step S207 in FIG. 4A.

The server apparatus 103 creates the data 1101 such that it has a structure in which information for transmitting the data 1101 to the local network 104 is included in the header of packet data which contains a search command or the like as the payload. To transmit the entire data from the server apparatus 103 to the information processing apparatus 101, the data is created such that the header of the data defines transmission from the network address S to the network address TI.

The search script of the information processing apparatus 101 which has received the packet data including the data 1101 takes out only contained packet data, and transfers the packet data to the local network 104 as data 1102. As shown in FIG. 15, the packet data in this case is addressed to BC. It is assumed that the destination BC indicates broadcast transmission. According to the above-described taking out of packet data executed by the search script, broadcasting of the search protocol-based message in the step S206 in FIG. 4A is realized.

Data 1103 is an example of packet data sent by the image input apparatus 102 as a response to the search command. The data 1103 has a header for transmission thereof from the network address D of the image input apparatus 102 to the network address TL of the information processing apparatus 101 on the local network 104. Further, the payload contains response information including the hardware information 221.

The search script having received the packet data of the data 1103 generates packet data containing the data 1103. The search script transfers the generated data as data 1104 from the network address TI to the network address S of the server apparatus 103. The network address TI is the address of the information processing apparatus 101 on the network 106 connected to the server apparatus 103 via the Internet 107.

By transmitting the data having the above-mentioned packet data structure to the server apparatus 103, the server apparatus 103 can acquire the network address TL of the information processing apparatus 101 on the local network 104. Similarly, the server apparatus 103 can acquire the network address D of the image input apparatus 102 having sent the response to the search command.

Data 1105 is an example of a scan script and a scan job message which are processed when it is determined in the step S230 in FIG. 4B that the driver 133 is not to be used. The data 1105 has the same packet data structure as the data 1101. More specifically, the data 1105 is created such that the header of the packet data containing e.g. a scan command as the payload includes information for transmission thereof to the local network 104. To transmit the entire data from the server apparatus 103 to the information processing apparatus 101, the data is created such that the header thereof defines transmission from the network address S to the network address TI.

The scan script having received the packet data of the data 1105 takes out only contained packet data, and transfers the packet data to the local network 104 as data 1106.

The server apparatus 103 has already acquired, from the data 1104, the network address TL of the information processing apparatus 101 on the network 104 and the network address D of the image input apparatus 102 having sent the response to the search command. The data 1105 is generated using these addresses, and hence the scan script can easily generate data which can be transmitted to the local network 104 only by routinely taking out the contained packet data part.

Data 1107 is an example of packet data transmitted by the image input apparatus 102 as image data generated as a result of the scan operation. The data 1107 has a header for transmission thereof from the network address D of the image input apparatus 102 to the network address TL of the information processing apparatus 101 on the local network 104. Further, the data 1107 contains image data information and the like in the payload.

The scan script having received the packet data of the data 1107 generates packet data containing the data 1107. The scan script transfers the generated packet data from the network address TI to the server apparatus 103 as data 1108.

Note that the image data is generated as the data 1107 in which the whole data is divided according to designation of the scan command. Further, the scan script sequentially processes the packets which are equivalent to the data 1107 and are sent a plurality of respective times. The data is transmitted to the server apparatus 103 with a data structure indicated by the data 1108, whereby it is possible to process the packet data even when the capacity of the RAM 112 used by the scan script is small.

Although not described in detail here, when the control of a network port is required, switching of the network port is described in a destination part of packet data together with a network address. This enables each script to cope with control of the network port by packet data generation including the conversion of the destination part.

Further, the search script and the scan script in the present embodiment can execute other functions. The scan script displays the scan setting screen 800 shown in FIG. 7, and transmits information set by the user to the server apparatus 103 as a message.

The search script and the scan script periodically check the status of the server apparatus 103 to thereby periodically check the server apparatus 103 as to whether or not update of the display contents is necessary. The server apparatus 103 sends a notification e.g. of error handling in the server apparatus 103 to the information processing apparatus 101 as a message, whereby the search script and the scan script can operate according to the message.

In the above-described embodiment, communication between the server apparatus and the image input apparatus via the information processing apparatus may be performed by any method insofar as it can be executed by the information processing apparatus. More specifically, communication may be performed using the ActiveX control, the Java (registered trademark) script, the Java (registered trademark) applet, or any of various types of plug-ins. However, it is efficient to perform preparations to be executed in the information processing apparatus in order of priority, because the server apparatus has choices of a plurality of execution methods, and is not required to have a function of a device which is most frequently used.

Further, to easily and efficiently perform bi-directional communication, it is also effective to use a bi-directional communication technique, such as Websockets http://dev.W3.Org/html5/WebSockets. When the technique e.g. of WebSockets is introduced, it is unnecessary to perform such processing as described above in which a script periodically sends an HTML file update request message to the server apparatus 103. Further, it is possible to update a message sent from the server apparatus 103 without a request from the information processing apparatus 101.

Further, it is also possible to realize the communication e.g. by using WS-Eventing or GENA (general event notification architecture) as a protocol for sending a notification.

Further, the search script operating on the information processing apparatus 101 can be operated using any suitable protocol insofar as the protocol is capable of properly notifying the search script of hardware information and makes it possible to obtain the same result. Therefore, the present invention is not limited to the above-described embodiment.

Further, as a method of performing a scan operation in an image input apparatus, the above-described embodiment employs a method of generating a scan job and transmitting the generated scan job to the image input apparatus. However, if it is possible to transmit general information, such as a scan job ticket, to an image input apparatus, it is also possible to perform the scan processing by employing this method.

Further, as the method of performing a scan operation in an image input apparatus, the above-described embodiment employs the method of generating a scan job and transmitting the generated scan job to the image input apparatus. However, if the image input apparatus can receive general information, such as a scan job ticket, it is possible to employ the method of transmitting the general information to the image input apparatus for performing the scan processing.

Further, when a driver which can be used by the selected image input apparatus is not found in the steps S231 to S233 in the above-described embodiment, there may be employed an embodiment in which a usable driver is installed (steps S500 and S501) and an environment in which the driver can be used is established.

In this case, an install package for the driver which can be used by the selected image input apparatus 102 is searched from the information processing apparatus 101 or an external apparatus which can be connected, such as a server apparatus, and if the install package of the driver which can be used by the image input apparatus 102 is found, the install package is downloaded and installed.

In a case of downloading the install package from an external apparatus, such as the server apparatus 103, it is necessary as a precondition that the server apparatus 103 and the information processing apparatus 101 have an arrangement for remotely downloading the install package of the driver and executing the installation. Further, in a search for the install package of the usable driver, whether a driver is usable is determined from information on the selected image input apparatus (name of the image input apparatus, ID information uniquely defined for each type of the image input apparatus, etc.).

This makes it possible to establish an environment in which the driver can be automatically installed and used even when the driver has not been installed in advance.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-123639, filed Jun. 1, 2011, which is hereby incorporated by reference herein in its entirety.

What is claimed is:

1. A server apparatus which is capable of communicating with an information processing apparatus, comprising:
a search script-providing unit configured to provide a search script to the information processing apparatus, for use in searching for a driver for using an image input apparatus selected by the information processing apparatus;
a program providing unit configured to be operable when it is determined by the search script provided by said search script-providing unit that the driver exists in the information processing apparatus, to provide a driver control program for controlling the driver to the information processing apparatus; and
a storage unit configured to acquire image data input by the image input apparatus using the driver controlled by the driver control program via the information processing apparatus, and store the acquired image data.

2. The server apparatus according to claim 1, wherein when it is determined by the search script that the driver does not exist or that the driver is not to be used, control script information for controlling the image input apparatus selected by the information processing apparatus is provided to the information processing apparatus.

3. An information processing apparatus which is capable of communicating with a server apparatus and an image input apparatus, comprising:
a selection screen display unit configured to acquire a list of image input apparatuses from the server apparatus, and display a selection screen for prompting a user to select an image input apparatus to be operated from the list;
a selection result-transmitting unit configured to transmit a selection result indicative of the image input apparatus selected by the user via the selection screen displayed by said selection screen display unit to the server apparatus;
a first acquisition unit configured to acquire a search script from the server apparatus, for use in searching for a driver for using an image input apparatus indicated by the selection result transmitted by said selection result-transmitting unit;
a second acquisition unit configured to be operable when it is determined by the search script acquired by said first acquisition unit that the driver exists in the information processing apparatus, to acquire a driver control program for controlling the driver from the server apparatus;
a display unit configured to display a setting screen for setting a manner of operation of the image input apparatus using the driver started by the driver control program acquired by said second acquisition unit; and
a control unit configured to control the image input apparatus by transmitting a job command indicative of the manner of operation set by the user from the setting screen displayed by said display unit to the image input apparatus.

4. The information processing apparatus according to claim 3, wherein if it is not determined by the search script acquired by said first acquisition unit that the driver exists in the information processing apparatus, a usable driver is searched for, and the driver found by the search is installed in the information processing apparatus.

5. A method of controlling a server apparatus which is capable of communicating with an information processing apparatus, comprising:
providing a search script to the information processing apparatus, for use in searching for a driver for using an image input apparatus selected by the information processing apparatus;
providing, when it is determined by the provided search script that the driver exists in the information processing apparatus, to provide a driver control program for controlling the driver to the information processing apparatus; and
acquiring image data input by the image input apparatus using the driver controlled by the driver control program via the information processing apparatus, and store the acquired image data.

6. A method of controlling an information processing apparatus which is capable of communicating with a server apparatus and an image input apparatus, comprising:
acquiring a list of image input apparatuses from the server apparatus, and displaying a selection screen for prompting a user to select an image input apparatus to be operated from the list;
transmitting a selection result indicative of the image input apparatus selected by the user via the displayed selection screen to the server apparatus;
acquiring a search script from the server apparatus, for use in searching for a driver for using an image input apparatus indicated by the transmitted selection result;
acquiring, when it is determined by the acquired search script that the driver exists in the information processing apparatus, to acquire a driver control program for controlling the driver from the server apparatus;
displaying a setting screen for setting a manner of operation of the image input apparatus using the driver started by the acquired driver control program; and
a control unit configured to control the image input apparatus by transmitting a job command indicative of the manner of operation set by the user from the displayed setting screen to the image input apparatus.

7. A non-transitory computer-readable storage medium storing a computer-executable program for executing a method of controlling a server apparatus which is capable of communicating with an information processing apparatus,
wherein the method comprises:
providing a search script to the information processing apparatus, for use in searching for a driver for using an image input apparatus selected by the information processing apparatus;
providing, when it is determined by the provided search script that the driver exists in the information processing apparatus, to provide a driver control program for controlling the driver to the information processing apparatus; and
acquiring image data input by the image input apparatus using the driver controlled by the driver control program via the information processing apparatus, and store the acquired image data.

8. A non-transitory computer-readable storage medium storing a computer-executable program for executing a method of controlling an information processing apparatus which is capable of communicating with a server apparatus and an image input apparatus,
wherein the method comprises:
acquiring a list of image input apparatuses from the server apparatus, and displaying a selection screen for prompting a user to select an image input apparatus to be operated from the list;
transmitting a selection result indicative of the image input apparatus selected by the user via the displayed selection screen to the server apparatus;
acquiring a search script from the server apparatus, for use in searching for a driver for using an image input apparatus indicated by the transmitted selection result;
acquiring, when it is determined by the acquired search script that the driver exists in the information processing apparatus, to acquire a driver control program for controlling the driver from the server apparatus;
displaying a setting screen for setting a manner of operation of the image input apparatus using the driver started by the acquired driver control program; and
a control unit configured to control the image input apparatus by transmitting a job command indicative of the manner of operation set by the user from the displayed setting screen to the image input apparatus.
